(19) United States
(12) Patent Application Publication
(10) Pub. No.: US 2016/0203559 A1
(43) Pub. Date: Jul. 14, 2016

(54) SYSTEM AND METHOD FOR FINANCIAL ADVISING BASED ON A GOAL ORIENTED TARGET

(71) Applicant: Christopher Carosa, Honeoye Falls, NY (US)

(72) Inventor: Christopher Carosa, Honeoye Falls, NY (US)

(21) Appl. No.: 15/079,037

(22) Filed: Mar. 23, 2016

Related U.S. Application Data
(63) Continuation-in-part of application No. 14/214,832, filed on Mar. 15, 2014.

(51) Int. Cl. G06Q 40/06

(52) U.S. Cl. CPC G06Q 40/06

(57) ABSTRACT

A system and method for financial advising based on a goal oriented target is disclosed. The system includes a financial advising based on a goal oriented target non-transitory storage media and a GOT input interface and a GOT versus frequency queue. The method includes generating a GOT percentage after the calculating GOT information is entered and compared the GOT versus frequency queue having a plurality of corresponding percentages with the GOT percentage to indicate GOT percentage quality.

### PRIORITY CLAIM AND RELATED APPLICATIONS

This Continuation-In-Part patent application claims the benefit of priority from Non-Provisional patent application U.S. Ser. No. 14/214,832 filed on Mar. 15, 2014, that claims the benefit of priority from Provisional application U.S. 61/788,864 filed on Mar. 15, 2013. Each of said applications is incorporated by reference in its entirety.

### BACKGROUND OF THE INVENTION

1. The Field of the Invention

The present invention is directed generally to a system and method for financial advising. More specifically, the present invention is directed to a system and method for financial advising based on a goal oriented target (GOT).

2. Background Art

Over the past decade, American investors increasingly have turned to mutual funds to save for retirement and other financial goals. Mutual funds may offer the advantages of diversification and professional management. However, as with other investment choices, investing in mutual funds involves risk. Further, fees and taxes diminish a fund's returns. It pays to understand both the upsides and the downsides of any type of investing and the methods by which to choose products that match one's goals and tolerance for risk.

One particular example is a presentation conducted by financial services firms for individuals to review an individual's financial portfolio. Such a presentation is used to present to customers information about their portfolio. Conventionally, such a presentation is conducted either in a face to face meeting with the individual where the details of a portfolio is presented either on a paper copy or displayed on a computer monitor, e.g., viewing financial statements on-line.

When it comes to investing in mutual funds, investors have literally thousands of choices. Typically, a fiduciary or financial advisor, by listening to an investor or client's goal for retirement income and the like, aids the client in determining the most suitable investment portfolio to create over the course of years to come with periodic revisions to the portfolio. Despite the financial advisor's good intentions and efforts in attempting to aid the client in understanding his investment tools and products, the advisor is still merely armed with charts demonstrating the overall views of groups of funds without any revelation of details at a shorter term scale. At the opposite spectrum, there are charts that may be requested by a prospective client that often show significant falls and rises even over periods such as days, weeks and months and lack meaningful indicators showing general trends. Advertisements, rankings, and ratings often emphasize how well a fund has performed in the past. Studies show that the future is often different, especially in light of short term past results. For example, this year's “number one” fund may easily become next year's below average fund. The amount of time a fund has been in existence also has bearing on the reliability of past performance. Newly created or small funds sometimes have excellent short-term performance records. As these funds may invest in only a small number of stocks, a few successful stocks may have a large impact on their performance. However, as these funds grow larger and increase the number of stocks they own, each stock has less impact on performance. This may make it more difficult to sustain initial results. While past performance does not necessarily predict future returns, it may indicate the volatility of a fund over a period of time. Generally, the more volatile a fund, the higher the investment risk. If money is needed to meet a financial goal in the near-term, one probably may not afford the risk of investing in a fund with a volatile history because there will not have enough time to ride out any declines in the stock market. It is therefore imperative to have funds evaluated at suitable periods, especially when regular contributions are made to such funds.

Volatility measures the variability in the price of an asset over time and is commonly calculated as annualized volatility without considering the link between this volatility and the client's financial goal. Common calculated data such as averages, standard deviations, highs and lows are often provided to provide a sense for volatility. Volatility measures are commonly tied to risks, i.e., the downturn that an individual may tolerate. All funds carry some level of risk and some clients may lose some or all of the money invested. In addition to the typical charts, there are personality profile evaluations that are geared towards estimating the amount of risk a client is willing to take. Although this may help in getting the client in line with the client's expectation, such profiles do nothing in establishing a goal and helping the client make decision based on the client's financial goal, e.g., in percentage gain, etc.

Product vendors and their paid salespeople generally control and often limit access to product information. Vendors typically do not want consumers of such financial products to have a practical way to objectively evaluate their products in comparison with those of others. Such an ability to objectively compare (i.e., comparatively evaluate) products being offered would effectively commoditize financial products, and would adversely impact the hoped for effect of the large advertising and marketing budgets of these large product vendors. Guarding against the risk that industry products such as mutual funds are not turned into commodities was listed as one of top challenges facing the Investment Company Institute's membership, as was stated in the Jun. 20, 2000 Financial Planning Journal of the Bureau of National Affairs.

Further, conventional performance reporting practices contain at least one fundamental flaw. The conventional standard performance reporting has been established by Chartered Financial Analyst (CFA®) Institute, the professional association for securities analysts which has become part of the Board of Certified Financial Planning (CFP) curriculum as well as the Institute of Certified Trust and Financial Advisor (CTFA) curriculum. Such reporting may be found in every Morningstar report and, since 2002, the Securities & Exchange Commission (SEC) now requires every mutual fund to include it in its prospectus.

The conventional performance reporting standard is the 1-year, 5-year and 10-year performance numbers portfolio managers report to the investing public. This conventional system was initially developed such that fiduciaries may be able to objectively compare different portfolios on a standardized basis. In addition, fiduciaries may be able to view the longer term performance of a fund and thus avoid making a decision based only on a single (especially short-term) period of time. The financial industry therefore concluded it should look at a wide range of universal performance reporting periods. This generally accepted principal led to the 1, 5 and 10-year performance reporting standard today. This broadly accepted standard however contains a significant flaw which may lead to potentially damaging results for the naïve investor or client and the fiduciary whose due diligence process incorporates the flaw. Such flaw is sometimes referred to as Snapshot-in-Time Anomaly. For years, professional portfolio managers have been aware of this flaw as they eagerly anticipated a bad performance year rolling out of a performance period over the course of time. The casual observer might brush this off as a matter already addressed by looking at the three different reporting periods. The damage caused by the flaw is most acute for long-term investors who contribute regularly to their portfolio. This includes nearly everyone who defers a portion of their wages into a retirement plan, and, most especially, to the plan trustees ultimately responsible for protecting plan beneficiaries.

U.S. Pat. Pub. 2009/0125450 of Mannion discloses a method and system for measuring investment volatility (e.g., total portfolio volatility of individuals) and/or investment performance (e.g., total portfolio performance of individuals). In one example, the method and system may be used for measuring investment volatility and/or investment performance of personal pension portfolios. In another example, the method and system may provide for measuring volatility of an investment portfolio held by an investor, comprising: providing first information indicating volatility of the investment portfolio over one or more predetermined periods of time; and providing second information indicating volatility of investment portfolios of the investor's peer group (e.g., on average) over the predetermined period(s) of time. This disclosure demonstrates a method and system by which volatility is measured. Again, it does not tie volatility in with a goal that is set by a client.

U. S. Pat. Pub. No. 2007/0038545 of Smith et al. discloses a consultation analysis for a 401K retirement savings plan comprising a plurality of informational elements. Participant profiles are a first one of the informational elements and are provided for each one of a plurality of classes of participants in the 401K retirement savings plan. A model portfolio is a second one of the informational elements and is provided for each one of the participant profiles. At least a portion of the model portfolios include a plurality of asset classes. Designation of a plurality of performance-quantified investment choices for each one of the asset classes is a third informational element. The performance quantified investment choices are performance-quantified with respect to at least one performance factor. Designation of a plurality of suggested ones of the investment choices for each one of the asset classes is a fourth informational element. This disclosure demonstrates the use of a complex set of parameters for facilitating management of 401K retirement savings plan where such practice is more suited for financial professionals and not suitable for use as aids presented to clients for investment decision-making purposes.

Thus, there arises a need for a simple financial advisory system which may be readily used by a financial advisor based on a system and method for financial advising based on a goal oriented target in contrast to investment return or asset allocation.

### SUMMARY OF THE INVENTION

The present invention is directed toward a system and method for financial advising based on a goal oriented target (GOT), comprising:
(a) a system for providing a first measure comprising a first ratio of the number of periods in which a return of the investment within the multi-period time span meets or exceeds a GOT to the total number of periods within the multi-period time span;
(b) a system for financial advising based on a goal oriented target that is adjustable with a plurality of financial advising elements;
(c) a method for financial advising based on a goal oriented target that is adjustable with a plurality of financial advising elements; and
(d) a non-transitory computer storage media having instructions stored thereon which, when executed, execute a method for financial advising based on a goal oriented target that is adjustable with a plurality of financial advising elements.

In one embodiment, the GOT is expressed in percentage point of the investment.

Accordingly, it is a primary object of the present invention to provide a financial advisory system which may be used to aid investors in allocating resources in assets by tying a client's financial goal with performance metrics that reflect the frequency and amplitude at which certain assets met and exceeded the financial goal in the past.

It is another object of the present invention to provide a financial advisory system which is simple, easily explainable to clients and thus enables clients to make educated choices in asset selection and/or allocation.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a system overview of a system for financial advising based on a goal oriented target (GOT), in accordance with the invention.

FIG. 2A illustrates a block diagram of a client system, in accordance with the invention.

FIG. 2B illustrates a block diagram of a server system, in accordance with the invention.

FIG. 3A illustrates a GOT input screenshot, in accordance with the invention.

FIG. 3B illustrates a GOT output screenshot, in accordance with the invention.

FIG. 4 depicts a conventional standard performance reporting of two funds.

FIG. 5 depicts a conventional annual performance reporting of two funds.

FIG. 6 depicts another conventional standard performance reporting of two funds.

FIG. 7 is a 5-year moving average of two funds, appropriately depicting the trends of two funds.

FIG. 8 is a queue showing returns from two funds over several periods where the queue is used to demonstrate the means by which the present frequency and amplitude are calculated.

FIG. 9 is another queue showing returns from two funds over several periods where the queue is used to demonstrate the means by which the present frequency and amplitude are calculated.

FIG. 10 is an example interface used for receiving client data and calculating a GOT based on the data.

FIG. 11 are queues demonstrating the amounts of annual contribution needed to result in the asset sizes listed in the queues based on a range of percentages of return.

FIG. 12 is an example queue listing several funds that have been short listed by a financial advisor and presented to a client for further selection of one or more funds from this short list.

FIG. 13 is an example color-coded queue of GOT versus frequency.

### PARTS LIST

2—Frequency
4—Amplitude
6—Value Corresponding to Worst 5-Year Period
8—Value Corresponding to Break-Even Amplitude
10—GOT
12—Fund A
14—Fund B
100—System
104—Server System
106—Input System
108—Output System
110, 114, 116, 118 and 120—Client System
112—Communication System
122—Hand-Held Device
200—Client System
202—Output System
204—Input System
206—Memory System
208—Processor System
212—Communications System
214—Input/Output System
216—Website
218—Wireless Portal
220—Power Source
230—Output System
240—Input System
250—Memory System
251—Operating System
252—Communications Module
253—Web Browser Module
254—Web Server Application
255—Financial Advising Based on a Goal Oriented Target Non-Transitory Storage Media
260—Processor System
270—Communications Interface
275—Communications System
280—Input/Output System
300—GOT Input Interface
305—Calculate Button
310—Annual Salary Fields
312—Annual Salary Field of Self
314—Annual Salary Field of Spouse
315—GOT Percentage
320—Retirement Savings Fields
322—Retirement Savings Field of Self
324—Retirement Savings Field of Spouse
330—Annual Contribution Fields
332—Annual Contribution Field of Self
334—Annual Contribution Field of Spouse
340—Years to Retirement Field
342—Number of Years Before Retirement
350—Projected Retirement Income Need Field
360—Override Button
362—Yes Override Button
364—No Override Button
370—Social Security Fields
372—Social Security of Self
374—Social Security of Spouse
380—Annual Pension Fields
382—Annual Pension of Self
384—Annual Pension of Spouse
390—Annual Outside Income Fields
392—Annual Outside Income of Self
394—Annual Outside Income of Spouse
400—GOT Input Interface
405—Calculate Button
410—Annual Salary Fields
412—Annual Salary Field of Self
414—Annual Salary Field of Spouse
415—GOT Percentage
420—Retirement Savings Fields
422—Retirement Savings Field of Self
424—Retirement Savings Field of Spouse
430—Annual Contribution Fields
432—Annual Contribution Field of Self
434—Annual Contribution Field of Spouse
440—Years to Retirement Field
442—Number of Years Before Retirement
450—Projected Retirement Income Need Field
460—Override Button
462—Yes Override Button
464—No Override Button
470—Social Security Fields
472—Social Security of Self
474—Social Security of Spouse
480—Annual Pension Fields
482—Annual Pension of Self
484—Annual Pension of Spouse
490—Annual Outside Income Fields
492—Annual Outside Income of Self
494—Annual Outside Income of Spouse
500—GOT vs. Frequency Queue
510—Percent GOT Values
520—Frequency Terms
530—Corresponding Percentages
540—Color Coding System

### PARTICULAR ADVANTAGES OF THE INVENTION

The present financial advisory system provides metrics, e.g., frequency and amplitude, which may reveal flaws which are otherwise hidden in conventional performance reporting practices. These metrics may be used to determine the most optimal investment choices to achieve a GOT calculated based on a client's retirement savings goal.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

The term “Goal Oriented Target or GOT” is defined as the percentage point return required by a client by the end of an investment period. The realistic GOT may range from about 2% to about 10%, although outliers may exist on either end of the spectrum.

The term “frequency” is used herein to mean the percentage of time in which an investment meets or exceeds a target. A frequency indicates how often the investment option met or exceeded a GOT. In this measurement, one does not care to what degree the investment option met or exceeded the GOT. One is concerned with whether one simply met or failed to meet the GOT. If an option met or exceeded the GOT only half the time, its frequency would equal 50%. Likewise, if the option met or exceeded the GOT all the time, its frequency would equal 100%.

The term “amplitude” is used herein to mean the likelihood of an investment of recovering from not meeting a target. An amplitude indicates to what degree a GOT is met or exceeded. In this measurement, one considers the degree to which one either met or failed to meet the GOT. One tries to get an idea of how much damage the failure to meet the GOT impacts one over time. As disclosed elsewhere herein, if the option met or exceeded the GOT only half the time, its frequency would equal 50%. This frequency indicates that one may have an equal chance of meeting or failing to meet the GOT. If the margin at which the GOT is missed equals the margin at which the GOT is surpassed, then the amplitude is 50%. However, if the GOT is missed by a wider margin than the GOT is surpassed, the amplitude falls below 50%. On the other hand, if the GOT is missed by a smaller margin than the GOT is surpassed, then the amplitude rises above 50%. Ideally, options that have amplitudes greater than 50% for any given GOT are preferred. Incidentally, if the option's frequency is 100% (i.e., it met or exceeded the GOT all the time), its amplitude would also be 100%.

The term financial advisor is used herein to mean a fiduciary, trustee or professional rendering financial advice or services to clients.

Disclosed herein is a system for providing investment metrics of an investment based on a multi-period time span, the system comprising:
(a) a system for providing a first measure comprising the number of periods in which the return of an investment within said multi-period time span meets or exceeds a GOT divided by the total number of periods within said multi-period time span; and
(b) a system for providing a second measure comprising the total amount of surpluses within the multi-period time span divided by the total amount of surpluses and gaps within the total number of periods in the multi-period time span.
For purposes of illustration but not limitation, the present examples are related to retirement calculations on mutual funds where contributions are regularly made, instead of a mere upfront, one time investment. It shall be understood that the present system may be applied to other investment instruments that are regularly priced, such as stocks, bonds, Exchange-Traded Funds (ETFs) and any other investment portfolios.

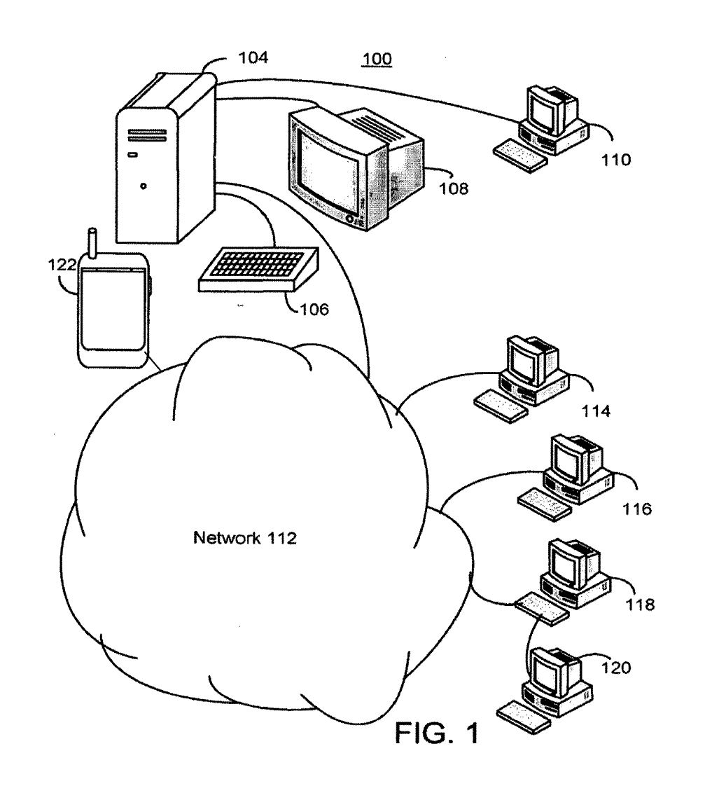

FIG. 1 illustrates a system overview of a system 100 for financial advising based on a goal oriented target. The system 100 includes a server system 104, an input system 106, an output system 108, a plurality of client systems 110, 114, 116, 118 and 120, a communications network 112 and a hand-held device 122. In other embodiments, the system 100 may include additional components and/or may not include all of the components listed above.

The server system 104 may include one or more servers. One server 104 may be the property of the distributor of any related software. In other embodiments, the system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (e.g., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The system 100 illustrates some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals. The client systems 110, 114, 116, 118 and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112 and another system, which in this example is client system 118. The client system 120 is an example of a handheld wireless device 122, such as a mobile phone or a handheld network enabled audio/music player, which may also be used for accessing network content.

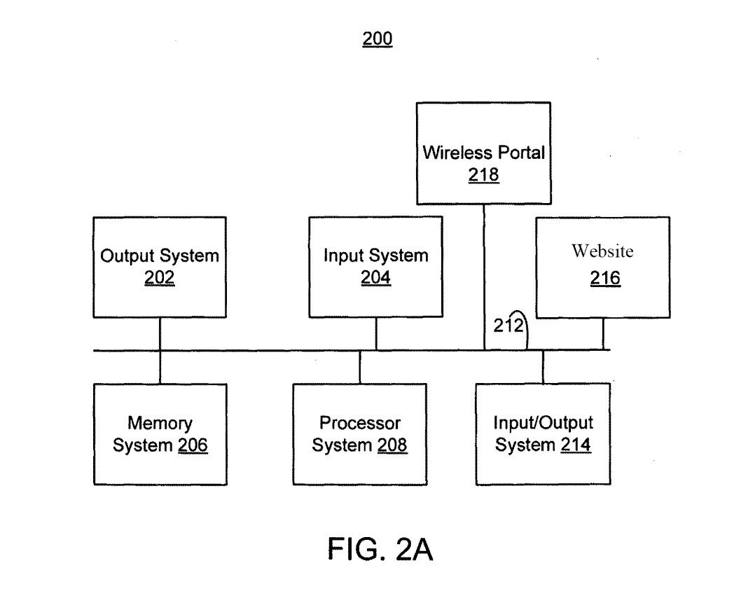

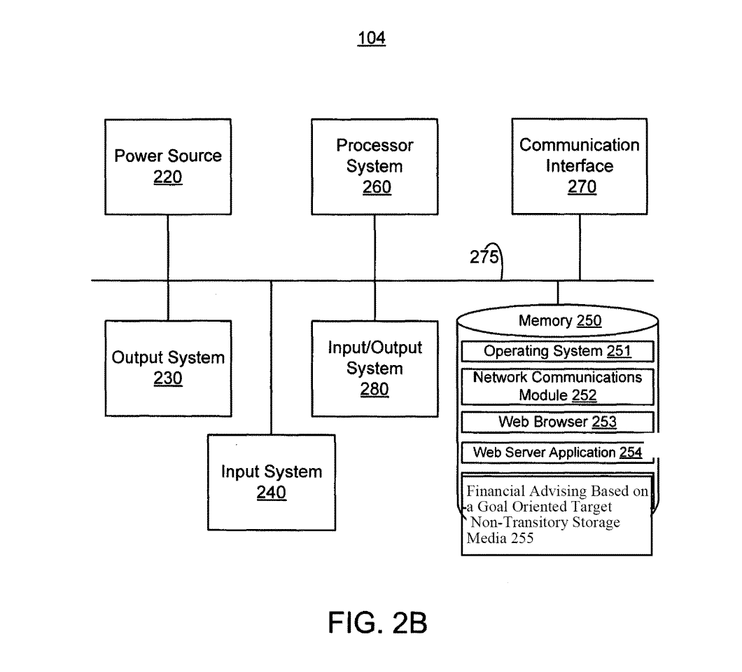

FIG. 2A illustrates a block diagram of a client system 200 that may be used as one of the system units for financial advising based on a goal oriented target. The client system 200 may include an output system 202, an input system 204, a memory system 206, a processor system 208, and a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or interface system to a sound system, an interface system to peripheral devices and/or a connection and/or an interface system to a computer system, an intranet, and/or the Internet, for example.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (e.g., Infrared Data Association or IrDA, Universal Serial Bus or USB), for example. The memory system 206 may include, for example, any one of, some of, any combination of or all of a long term storage system, such as a hard drive, a short term storage system, such as a random access memory; a removable storage system, such as a floppy drive or a removable drive, and/or a flash memory. The memory system 206 may include one or more machine readable mediums that may store a variety of different types of information. The term machine readable medium is used to refer to any medium that is structurally configured for carrying information in a format that is readable by a machine. One example of a machine-readable medium is a computer-readable medium. The memory system 206 also stores an application for financial advising based on a goal oriented target.

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively links the output system 202, the input system 204, the memory system 206, the processor system 208, and/or the input/output system 214 to each other. The communications system 212 may include any one of, some of, any combination of, or all of one or more electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional, and may be used in addition to or in place of the output system 202 and/or the input device 204. The client systems 110, 114, 116, 118, 120 and the handheld wireless device 122 may also be tied into a website 216 or a wireless portal 218 which is also tied directly into the communications system 212. Any website 216 or wireless portal 218 would also include software and a website module (no number) to maintain, allow access to and run the website as well.

FIG. 2B illustrates a block diagram of a server system 104 that may be used for financial advising based on a goal oriented target. The server system 104 may include a power source 220, an output system 230, an input system 240, a memory system 250, which may store an operating system 251, a communications module 252, a web browser module 253, a web server application 254 and a financial advising based on a goal oriented target non-transitory storage media 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (e.g., IrDA, USB), for example.

The memory system 250 may include, for example, any one of, some of, any combination of, or all of a long term storage system, such as a hard drive; a short term storage system, such as random access memory; a removable storage system, such as a floppy drive or a removable drive and/or a flash memory. The memory system 250 may include one or more machine readable mediums that may store a variety of different types of information. The term machine readable medium is used to refer to any medium capable carrying information that is readable by a machine. One example of a machine-readable medium is a computer-readable medium. The memory system 250 may store one or more machine instructions for financial advising based on a goal oriented target. The operating system 251 controls all software and hardware of the system 100. The communications module 252 enables the server system 104 to communicate on the communications network 112. The web browser module 253 allows for browsing the Internet. The web server application 254 serves a plurality of interfaces to client systems that request the interfaces, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively links the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

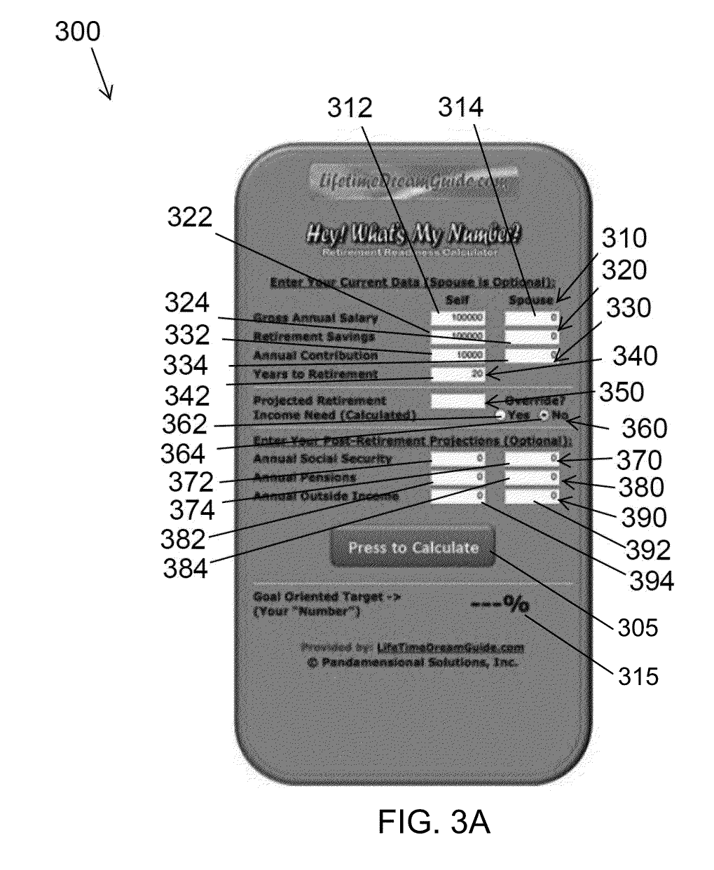

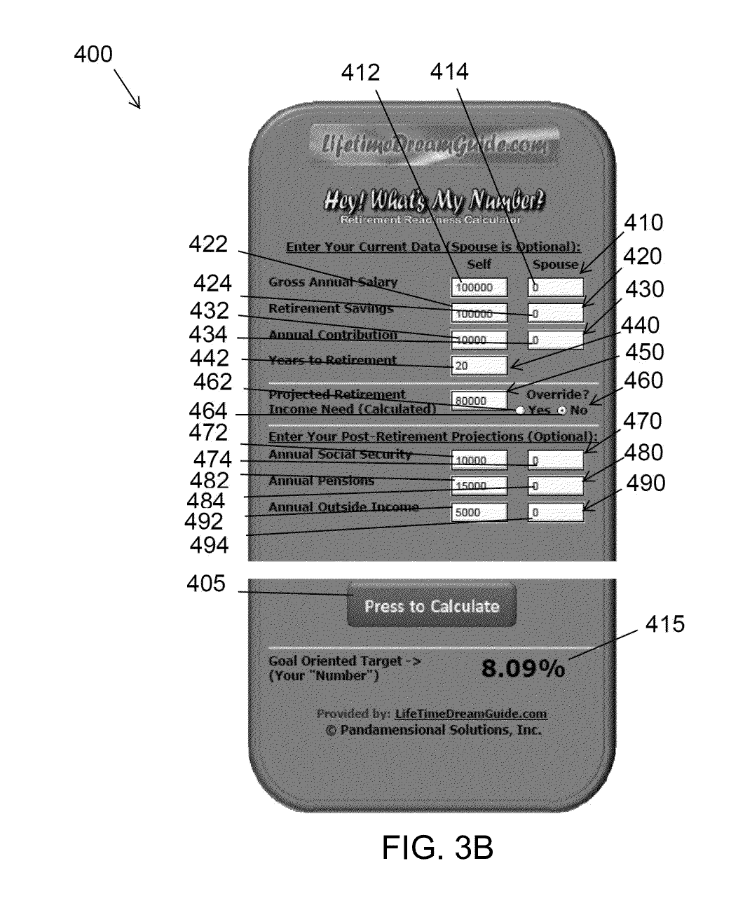

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240. FIG. 3A illustrates a GOT input interface 300, in accordance with the invention. The GOT input interface 300 may include a pair of gross annual salary fields 310, a pair of retirement savings fields 320, a pair of annual contribution fields 330, a years to retirement field 340, a projected retirement income needed field 350, a pair of override buttons 360, a pair of annual social security fields 370, a pair of annual pension fields 380 and a pair of annual outside income fields 390.

The pair of gross annual salary fields 310 may include a self-annual salary field 312 and a spouse self-annual salary field 314. FIG. 3A illustrates a self-annual salary field 312 of $100,000 and a spouse self-annual salary field 314 of $0. The pair of retirement savings fields 320 may include a self retirement savings field 322 and a spouse retirement savings field 324. FIG. 3A illustrates a self retirement savings field 322 of $100,000 and a spouse retirement savings field 324 of $0. The pair of annual contribution fields 330 may include a self annual contribution field 332 and a spouse annual contribution field 334. FIG. 3A illustrates a self annual contribution field 332 of $10,000 and a spouse annual contribution field 334 of $0. The years to retirement field 340 may include the number of years before retirement 342. FIG. 3A illustrates a years to retirement field of 20 years. The projected retirement income needed field 350 may include an amount of money needed for retirement after working. The pair of override buttons 360 may include a yes override button 362 and a no override button 364. FIG. 3A illustrates a no override button 364 filled-in or depressed. The pair of annual social security fields 370 may include a self-annual social security field 372 and a spouse annual social security field 374. FIG. 3A illustrates a self-annual social security field 372 of $0 and a spouse annual social security field 374 of $0. The pair of annual pension fields 380 may include a self annual pension field 382 and a spouse annual pension field 384. FIG. 3A illustrates a self annual pension field 382 of $0 and a spouse annual pension field 384 of $0. The pair of annual outside income fields 390 may include a self annual outside income field 392 and a spouse annual outside income field 394. FIG. 3A illustrates a self annual outside income field 392 of $0 and a spouse annual outside income field 394 of $0.

The GOT input interface 300 may also include a press to calculate button 305 and a GOT percentage 315. The press to calculate button 305 may be depressed after the pair of gross annual salary fields 310, the pair of retirement savings fields 320, the pair of annual contribution fields 330, the years to retirement field 340, the projected retirement income needed field 350, the pair of override buttons 360, the pair of annual social security fields 370, the pair of annual pension fields 380 and the pair of annual outside income fields 390 are entered and completed. The GOT percentage 315 may be generated after the press to calculate button 305 is depressed.

FIG. 3B illustrates a GOT output interface 400 after calculating GOT, in accordance with the invention.

The GOT input interface 400 may include a pair of gross annual salary fields 410, a pair of retirement savings fields 420, a pair of annual contribution fields 430, a years to retirement field 440, a projected retirement income needed field 450, a pair of override buttons 460, a pair of annual social security fields 470, a pair of annual pension fields 480 and a pair of annual outside income fields 490.

The pair of gross annual salary fields 410 may include a self-annual salary field 412 and a spouse self-annual salary field 414. FIG. 3B illustrates a self-annual salary field 412 of $100,000 and a spouse self-annual salary field 414 of $0. The pair of retirement savings fields 420 may include a self retirement savings field 422 and a spouse retirement savings field 424. FIG. 3B illustrates a self retirement savings field 422 of $100,000 and a spouse retirement savings field 424 of $0. The pair of annual contribution fields 430 may include a self annual contribution field 432 and a spouse annual contribution field 434. FIG. 3B illustrates a self annual contribution field 432 of $10,000 and a spouse annual contribution field 434 of $0. The years to retirement field 440 may include the number of years before retirement 442. FIG. 3B illustrates a years to retirement field of 20 years. The projected retirement income needed field 450 may include an amount of money needed for retirement after working. FIG. 3B illustrates a projected retirement income needed field 450 of $80,000. The pair of override buttons 460 may include a yes override button 462 and a no override button 464. FIG. 3B illustrates a no override button 464 filled-in. The pair of annual social security fields 470 may include a self-annual social security field 472 and a spouse annual social security field 474. FIG. 3B illustrates a self-annual social security field 472 of $10,000 and a spouse annual social security field 474 of $0. The pair of annual pension fields 480 may include a self annual pension field 482 and a spouse annual pension field 484. FIG. 3B illustrates a self annual pension field 482 of $15,000 and a spouse annual pension field 484 of $0. The pair of annual outside income fields 490 may include a self annual outside income field 492 and a spouse annual outside income field 494. FIG. 3B illustrates a self annual outside income field 492 of $5,000 and a spouse annual outside income field 494 of $0.

The GOT input interface 400 may also include a press to calculate button 405 and a GOT percentage 415. The press to calculate button 405 may be depressed after the pair of gross annual salary fields 410, the pair of retirement savings fields 420, the pair of annual contribution fields 430, the years to retirement field 440, the projected retirement income needed field 450, the pair of override buttons 460, the pair of annual social security fields 470, the pair of annual pension fields 480 and the pair of annual outside income fields 490 are entered and completed. The GOT percentage 415 may be generated after the press to calculate button 405 is depressed.

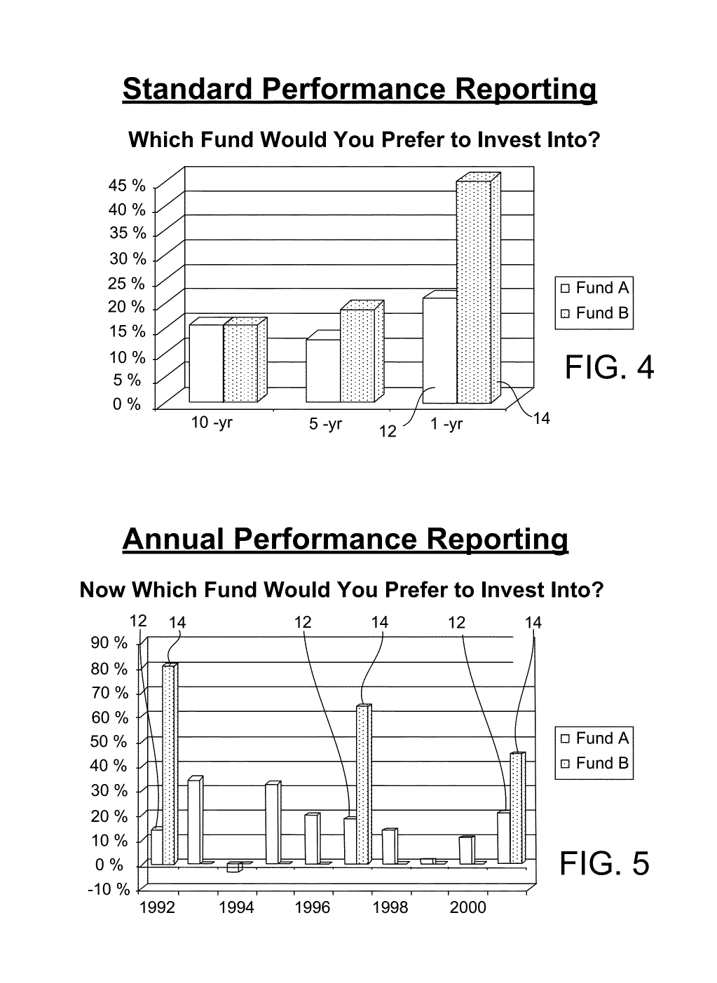

FIG. 4 shows a conventional standard performance reporting and comparison between two hypothetical substantially similar funds with a long-term investment objective. This represents a graphical depiction of the 10-year, 5-year and 1-year performance reporting periods required by the Securities & Exchange Commission (SEC). A typical fiduciary would take advantage of this information to compare the two funds. Most trustees would most likely invest in Fund B 14. The reason shall be obvious. Fund B has performed better than Fund A 12 in the most recent periods and equal to Fund A in the longest (10-year) period.

FIG. 5 depicts a conventional annual performance reporting which does not clearly discern the portfolio which offers the best potential. While Fund B has several 0% return years, however, when it performs, its performance exceeds the best performance of Fund A. Fund A, on the other hand, though resplendent with many positive years, does have a couple of bad years, including one significant negative year, i.e., at year 1994. The fact that regular contributions are made only complicates matters.

In looking at both performance charts of FIGS. 4 and 5 there may be a tendency to select Fund B. After all, it appears to both preserve wealth (it has no down years in FIG. 5) yet offers a comparable long-term return (FIG. 4 shows it has the same ten-year return as Fund A). Unfortunately, most retirement plans, most notably 401k plans, feature regular contributions. Given this, what real-life impact would each fund's respective return have on a typical plan beneficiary? This practical question mimics the kind of decisions plan trustees across the nation must make every day. Assume that one must choose between Fund A and Fund B for one of these investment options. Without additional metrics, it would have been difficult to select one of the two funds to invest in.

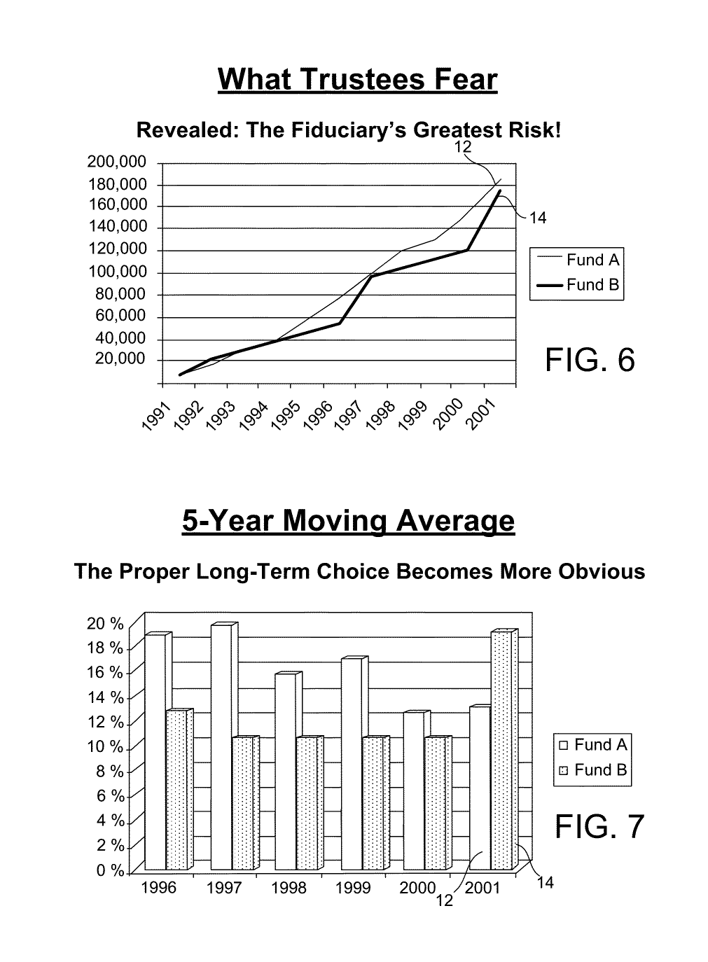

FIG. 6 shows the impact periodic contributions have on the actual ending dollar value when investing the exact same amount in each fund ($8,000) at the beginning of each of the ten years of our study. Surprisingly, it has been discovered that a typical 401k beneficiary would have $10,000 more to spend by investing in Fund A, despite each fund having an identical 10-year performance record. This difference could be quite substantial for the average employee investing in a 401k retirement plan. Furthermore, to emphasize the critical issue of the timing of reporting periods, an employee that retired in 2000 (i.e., a year before the end of the reporting period), would have 26% more assets by investing in Fund A versus Fund B. The Securities and Exchange Commission (SEC) does not require funds or mutual fund rating organizations to present performance reporting data in a manner that is both relevant to and easily applicable to retirement plan trustees and their beneficiaries. This conventional way of looking at investment performance, though generally accepted by the government and industry, may inadvertently imperil fiduciaries and the investing public.

FIG. 7 represents a series of rolling 5-year performance returns (i.e., the 5-year moving average). For example, the bars entered above 1996 contain the returns for the period from 1992 to 1996. The bars entered above the space for 1997 contain the returns for the period from 1993 to 1997. Unlike FIG. 5, which shows distinct annual returns, FIG. 7 contains overlapping periods. The Applicant discovered that 5-year periods are minimum suitable time spans as they are the shortest generally recognized long-term periods in order to maximize the information yield based on the data available to the public (i.e., annual data). It shall be noted that while FIG. 7 may appear to contain less data than FIG. 4 (in particular, the 10-year total investment return) and FIG. 5 (ten years of annual investment returns), in fact, FIG. 7 contains the exact same performance data (but does so in a more revealing manner). A graph of rolling 5-year annualized performance returns offers a significant advantage for long-term investors, especially those who contribute regularly to their portfolios, (e.g., employees who defer a portion of their earnings into a 401k plan). This type of graph quickly shows the investor the range of long-term returns that might be expected when investing recurrently over any period of time. For example, if an investment was made in 1995, in five years, the investment would yield more than 16% in Fund A versus about 10% in Fund B (this is represented by the bars above the year 1999—i.e., five years after the initial investment). By examining FIG. 7, the typical fiduciary, for example, would immediately see Fund A represents the more consistently attractive investment over time.

In general, Fund A outperforms Fund B in every rolling five-year period except for the last one; hence, the Snapshot-in-Time Anomaly that we saw earlier. This flaw is similar to the “blinker” problem encountered by securities analysts who screen for stocks. Very often, a stock will appear on last month's screen, but not on this month's screen. An analyst who does not regularly run screens might buy a stock that appears on a screen due only to the accident of timing. In the present example, the rolling five-year graph allows the trustee to see the results of several “screens” all on one graph. Therefore, a trustee who only looks at the most recent reporting period stands to make an unfortunate and potentially damaging investment decision. An investor who fails to undertake comprehensive due diligence only hurts himself or herself. A fiduciary that makes the same mistake unnecessarily exposes himself and his company to a liability that may otherwise be easily avoided.

Unfortunately, government and industry continues to employ the traditional performance reporting standard; thus, leaving the investing public and fiduciaries vulnerable and vastly uninformed. As a result, until a new standard is adopted, smart fiduciaries who seek to conduct the necessary due diligence must create sometimes complicated spreadsheet algorithms to extract rolling five-year charts. Upon reading the ensuing disclosure, it shall be apparent that the Applicant has provided metrics and a system for providing such metrics which may aid a financial advisor and a client in making informed investment decisions.

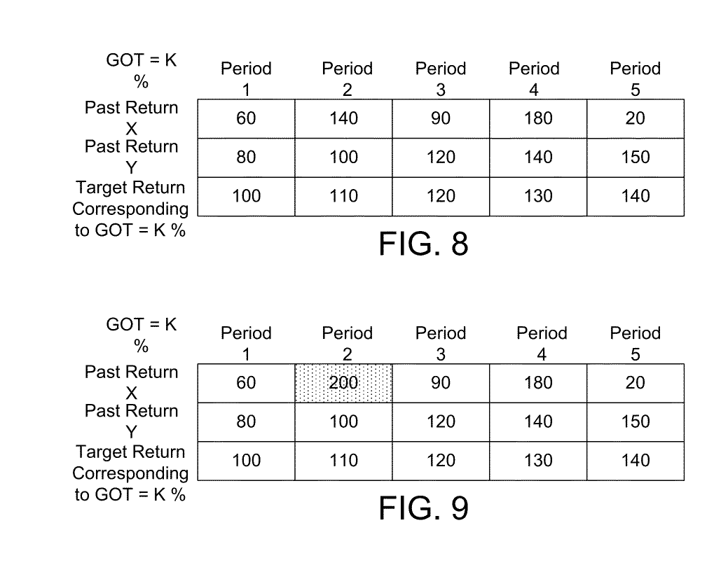

FIG. 8 is a queue showing returns from two funds (X and Y) over several periods where the queue is used to demonstrate the means by which the present frequency and amplitude are calculated. In calculating a frequency and amplitude, returns on an investment for a number of periods in the past are obtained. For instance, if a retirement calculation is to be made, the number of years in which contributions (number of years to retirement) are to be made may be taken as the number of periods. In this example, the returns of funds X and Y in the past five periods are 60, 140, 90, 180, 20 and 80, 100, 120, 140, 150, respectively. The magnitude of each number represents the size of a return. In order to achieve a GOT of K %, the return expected is 100, 110, 120, 130, and 140 for Period 1, 2, 3, 4, and 5, respectively. Frequency may be further expressed as the number of periods in which the return of an investment within the total number of periods under consideration meets or exceeds GOT divided by the total number of periods (e.g., 5 in this example) under consideration. Frequency may be further represented as follows:

Frequency=Σ(#Periods when Return≧GOT)/Σ(#Periods)

Therefore, frequencies of X and Y are ⅖ or 40% and ⅗ or 60%, respectively. Considered singly, frequency Y is viewed more favorably as it is higher than frequency X.

Amplitude may be expressed as the total amount of surpluses within the total number of periods under consideration divided by the total amount of surpluses and gaps within the total number of periods under consideration. Amplitude may be further represented as follows:

$$Amplitude = \sum ( ( Return - GOT ) if Return \geq GOT ) \text{/} \sum \vert Return - GOT \vert$$

$$Where amplitude X = ( ( 140 - 110 ) + ( 180 - 130 ) ) \text{/} ( \vert ( 60 - 100 ) \vert + \vert ( 140 - 110 ) \vert + \vert ( 90 - 120 ) \vert + \vert ( 180 - 130 ) \vert + \vert ( 20 - 140 ) \vert ) = 29.6 \%$$

$$and amplitude Y = ( ( 120 - 120 ) + ( 140 - 130 ) + ( 150 - 140 ) ) \text{/} ( \vert ( 80 - 100 ) \vert + \vert ( 100 - 110 ) \vert + \vert ( 120 - 120 ) \vert + \vert ( 140 - 130 ) \vert + \vert 150 - 140 ) \vert = 40 \%$$

In the examples disclosed herein, frequencies and amplitudes are expressed in percentage points, as such use is in line with the percentage gain of an investment, e.g., mutual funds, stocks and other financial instruments. Considered singly, amplitude Y again, is viewed more favorably as it is higher than amplitude X. A surplus is defined as the difference between a return and the value corresponding to a GOT when the return is greater than the value corresponding to the GOT. A gap is defined as the difference between a return and the value corresponding to a GOT when the return is less than the value corresponding to the GOT.

FIG. 9 is another queue showing returns from two funds over several periods where the queue is used to demonstrate the means by which the present frequency and amplitude are calculated. Note that the past return X has been altered to a value of 200 in Period 2 instead of the value of 140 as in FIG. 8. Applying the same formula disclosed elsewhere herein, the following frequency and amplitude result. Frequencies X and Y are ⅖ or 40% and ⅗ or 60%, respectively. Amplitude Y remains unchanged at 40%. Amplitude is calculated below.

$$Amplitude X = ( ( 200 - 110 ) + ( 180 - 130 ) ) \text{/} ( \vert ( 60 - 100 ) \vert + \vert ( 200 - 110 ) \vert + \vert ( 90 - 120 ) \vert + \vert ( 180 - 130 ) \vert + \vert ( 20 - 140 ) \vert ) = 42.4 \%$$

Note that although the frequency X is still lower than frequency Y, amplitude X is now higher than amplitude Y. In other words, although X does not meet or exceed target as often as Y, but when it does, it meets or exceeds target with higher margins. It is therefore imperative, in light of the above examples that frequency and amplitude shall be considered simultaneously.

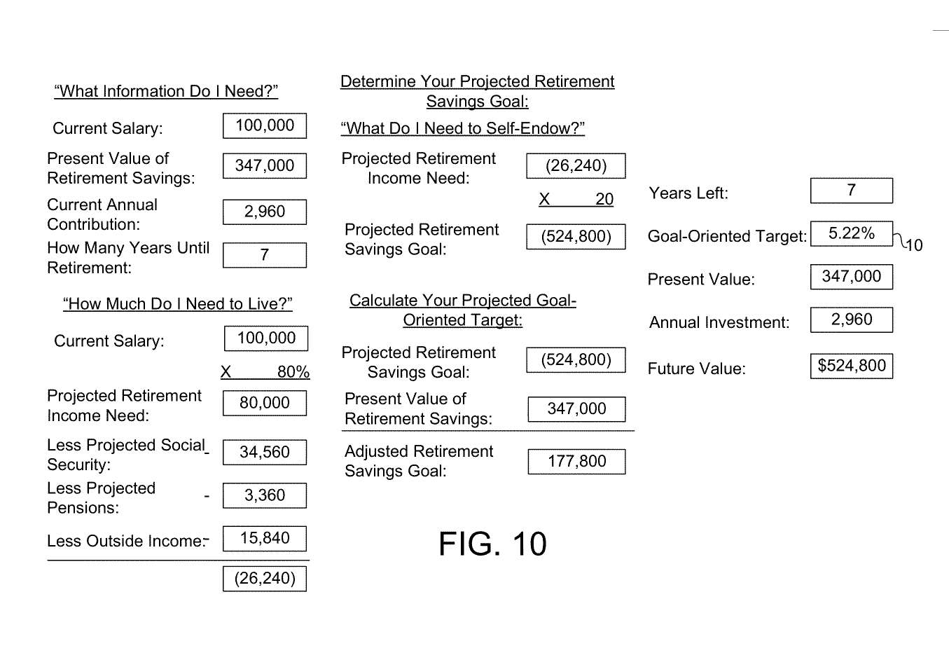

FIG. 10 is an example interface used for receiving client data and calculating a GOT based on the client data. This interface is configured to receive information such as the current salary, present value of retirement savings, current annual contribution, number of years until retirement, projected retirement income need, reduction in retirement need due to social security, reduction in retirement need due to pensions, reduction in retirement need due to outside income. Based on the data provided, in order to achieve an adjusted retirement savings goal of $177,800 in 7 years, a GOT of 5.22% is necessary. In a preferred embodiment as shown herein, GOT is expressed in percentage point adjusted retirement savings goal. Again, the use of percentage point in GOT is in line with the percentage gain of an investment, e.g., mutual funds, stocks and other financial instruments.

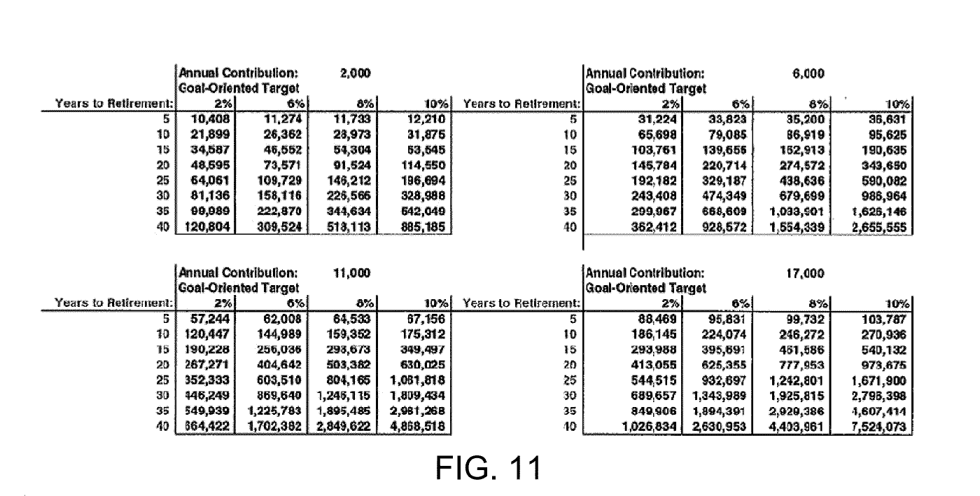

FIG. 11 are queues demonstrating the amounts of annual contribution needed to result in the asset sizes listed in the queues based on a range of percentages of return. These charts are typically supplied along with an interface, e.g., one disclosed on FIG. 10 such that a client, at an initial meeting with a financial advisor, may, at a glance, determine the amount of annual contribution that will need to be made in order to achieve a certain GOT. For instance, for a span of 10 years to retirement, in order to achieve 8% GOT, an annual contribution of $6,000 will be necessary. As another example, for a 2% GOT, an annual contribution of $2000 will result in a total of $10,408 at the end of the fifth year.

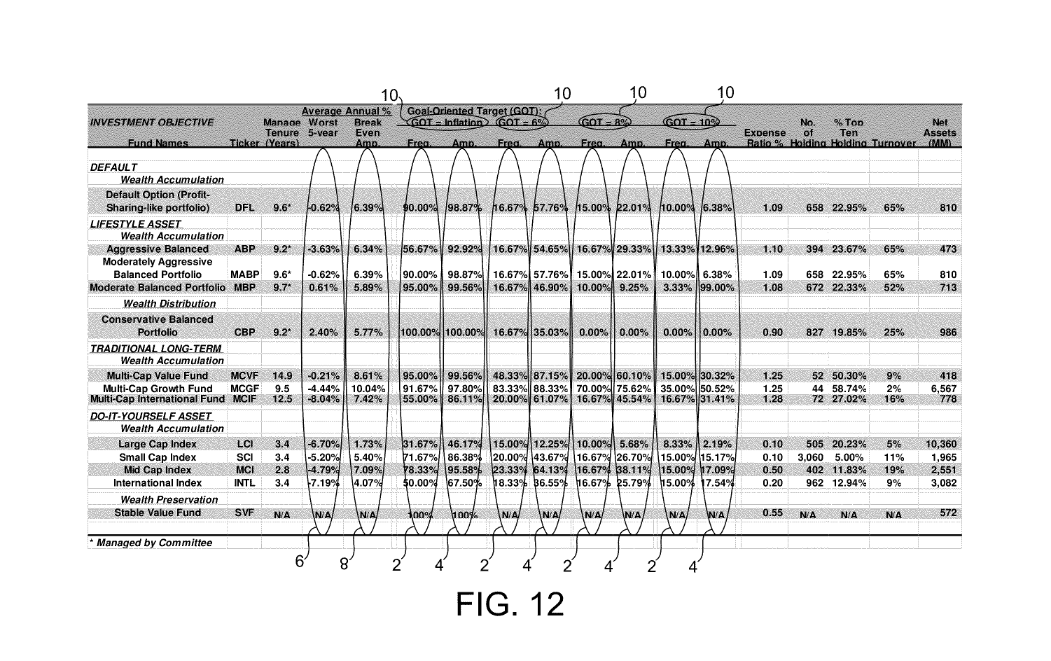

Upon receiving the GOT as shown in FIG. 10, a financial advisor is ready to present choices of investment instruments such as mutual funds and stocks to the client. FIG. 12 is an example queue listing several funds that have been short listed by a financial advisor and presented to a client for further selection of one or more funds from this short list. In FIG. 12, an example of twelve funds grouped in four fund groups is presented to the client. The client may choose to allocate his or her asset in one or more of these groups. A financial advisor typically works with a plurality of funds ranging from high risk with potentially high reward to conservative funds, i.e., a spectrum catering to investors willing to consider taking various levels of risks. The fund groups are represented by “Default,” “Lifestyle Asset Allocation,” “Traditional Long-Term Growth” and “Do-It-Yourself Asset Allocation.” The frequency 2 and amplitude 4 of each fund are calculated and listed under a GOT representing a typical GOT 10 value as a result of the “expected” GOT 10 calculation made in FIG. 10. In this case, frequencies 2 and amplitudes 4 are calculated for GOTs 10 corresponding to an inflation rate, 6%, 8% and 10% as these are commonly referenced values and a client, upon being introduced to such metrics may quickly grasp the meaning of such data and be able to use it to make informed decisions on his or her investment choices, such as selecting one fund over another. Referring back to and using the calculated GOT of 5.22% in FIG. 10, the closest GOT data that may be used for evaluating the funds is the GOT=6% data. For instance, if the client is interested in evaluating “MCVF” and “MCGF,” the client may quickly notice that both the frequency and amplitude of MCGF (83.33%, 88.33%) are higher than those of MCVF (48.33%, 87.15%) and therefore MCGF should be viewed more favorably than MCVF. However, when the worst 5-year data 6 is examined, it shall be noted that the −4.44% of MCGF is worse than the −0.21% of MCVF as the value of −4.44% is more negative than the value of −0.21%.

In one embodiment, a knowledge base including a plurality of expert rules is established in a computing device for evaluating and selecting an investment based upon the inventor's GOT. A ranked listing of investments may be generated based upon the frequencies and amplitudes obtained. For instance, a scoring system employing a weighting scheme may be applied to a frequency and its corresponding amplitude. In one example, a score is the total of (K1*frequency) and (K2*amplitude) where K1 and K2 are weighting factors. Various expert rules may be applied where the expert rules reflect the importance an investor places on financial factors. For instance, a reserved investor may choose a larger K1 value as the consistency in performance is more important than potentially high risk (and/or high volatility) but potentially high reward type of investment. On the other hand, an investor willing to take risk may tolerate a smaller K1 for a higher K2. As a result of applying expert rules, one or more ranked listings of investments may be generated for an investor to facilitate investment decisions.

In one embodiment, break-even amplitude 8 is further provided. This is an approximation of a particular annual return at which the degree by which a GOT is missed is exactly offset by the degree by which the GOT is surpassed. This is the annual return at which the amplitude equals 50% and represents the return at which one has an even (i.e., 50%) chance of meeting the GOT by investing regularly in the specific investment option being analyzed. The break-even amplitude 8 of each fund provides a basis upon which its amplitude may be compared to such that a sense of “how much better than average” may be gleaned from such comparison. A greater departure of amplitude from its break-even amplitude, the more favorably the amplitude is viewed.

In yet another embodiment, a worst period is further provided. This is the lowest annual return that an option meets or exceeds a GOT all the time, i.e., with its frequency equal to 100%. In other words, it is the worst return experienced in any five-year rolling period over the entire time span reviewed. The Applicant discovered that by further providing any one of these two measures, a client may better grasp the meaning of amplitude as the break-even amplitude represents an “average” return within the multi-period under consideration while the worst period represents the worst case that happened within the multi-period under consideration.

Referring back to FIG. 8, the break-even amplitude is obtained by iterating the target return corresponding to GOT=K % until the amplitude arrives at 50%. For instance, in order to calculate the break-even amplitude of X, the target return corresponding to GOT=K % is adjusted down to 99 such that an amplitude may be calculated for X. If such amplitude is 50%, a break-even amplitude has been found. If such amplitude is not 50%, the target return corresponding to GOT=K % may be further adjusted down to 98 such that an amplitude may be calculated again for X. This process is repeated until a 50% amplitude is found. Referring back to FIG. 8, the worst periods for X and Y are period 5 and period 1, respectively. The return corresponding to the worst period may also be presented as a percentage point by contrasting the return (20 for X and 80 for Y) of the worst period with the target return corresponding to GOT=K %. Likewise, the break-even amplitudes of X and Y may also be contrasted with their respective target return corresponding to GOT=K % such that they may be presented as percentage points.

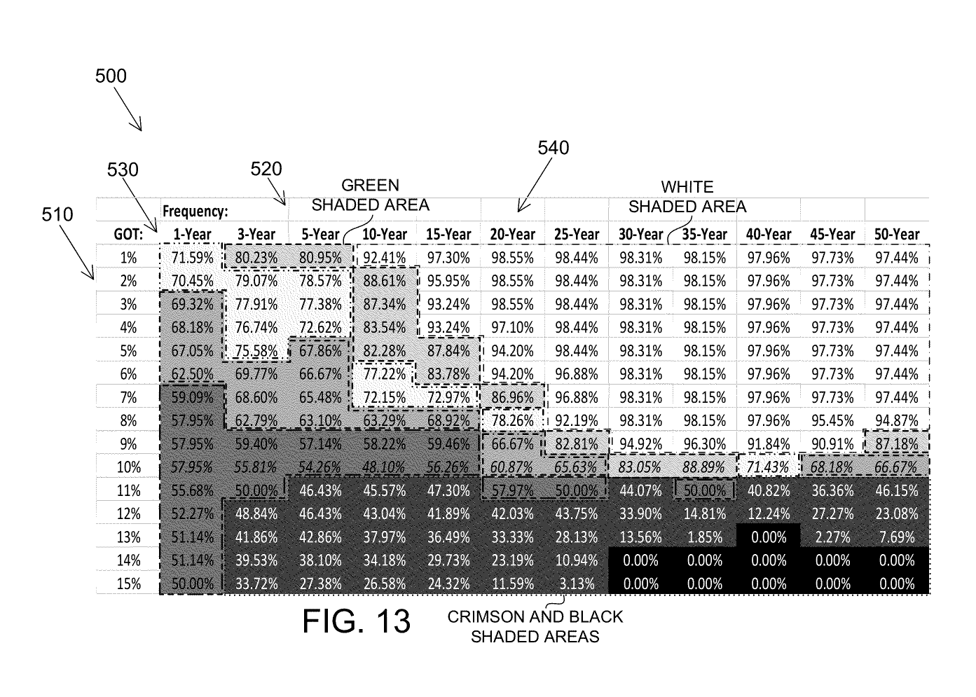

FIG. 13 is an example a GOT versus frequency queue 500. The GOT versus frequency queue 500 illustrated in FIG. 13 is color-coded to indicate stability and value of GOT. The GOT versus frequency queue 500 may include a plurality of percent GOT values 510, a plurality of predetermined frequency terms 520, a plurality of corresponding percentages 530 and a color coding system 540. A block having cells represented by a color is bounded by broken or dashed lines of a particular type. The percent GOT values 510 may be the percent GOT value calculated from the system (FIG. 1, 100). The percent GOT values 510 may be in the approximate range of 1 percent to 15 percent in approximate whole number increments such as 2 percent, 3 percent, 4 percent, 5 percent, etc. The percent GOT values 510 may be expressed on the rows of the GOT versus frequency queue 500. The predetermined frequency terms 520 may represent the number of years until retirement. The predetermined frequency terms 520 may be in the approximate range of 1 year to 50 years in approximate whole number increments such as 1 year, 5 year, 10 year, 15 years, 20 years, etc. The corresponding percentages 530 may represent the summation of all the stock returns from 1926 through 2013 (data courtesy of Ibbotson Associates, a division of Morningstar and a leading provider of historical market return data). The corresponding percentages 530 may correspond to the percent GOT values 510 and the predetermined frequency terms 520 on the GOT versus frequency queue 500. The corresponding percentages 530 may correspond to any approximate percentage value between 99.99 percent and 0.01 percent measured to the 0.01 percentage.

To use the GOT versus frequency queue 500, find the row and column that comes closest to the corresponding percentages 530. The corresponding percentages 530 represent the summation of all the stock returns from 1926 through 2013 (data courtesy of Ibbotson Associates, a division of Morningstar and a leading provider of historical market return data). For some years, for a member of the fiduciarynews.com retirement adviser community may gain access to similar corresponding percentages 530. For example, a corresponding percentage of 87.34% means that for all rolling 10-year periods, the investment return met or exceeded the GOT of 3% a grand total of 87.34% of the time. The 87.34% is relatively good that most investors would be happy with. The 87.34% corresponding percentage may be thought of as the frequency or “how frequently the actual results for this time period was met or exceeded the GOT.” The color coding system is coded where dark colored GOT percentages have low GOT percentages and light colored GOT percentages have high GOT percentages.

In another example, consider someone who will retire 40 years from now and has a GOT of 14%. We see where the lines intersect and we find a GOT of 0.00%. That is bad because it means in the last 88 years, there are no 40 year periods of stock market returns that yielded an annual return of at least 14%. This person will definitely want to improve a retirement investor's goal-oriented target to find out how to lower his GOT. The closer to the green and white shading on the queue, the better it is. Black is bad, it means there's been no period in recent history where stocks produced returns needed to match that GOT. In fact, one might venture to say anything where the figures themselves are in white (i.e., the black and crimson portion of the queue) should be considered bad. In all these cases, the frequency (i.e., the chances of meeting or exceeding your GOT) is less than 50%. You might say, those people with GOTs and years to retirement equating to a white number might be in trouble, (i.e., a very dangerous situation when it comes to retiring in comfort).

Obviously, black numbers on a white background is best, but anything in a green background is acceptable. Since many people have at least 15 years to go before they retire, this mean any GOT at or below 6% is an acceptable number. Bear in mind this one thing about the average stock market return over this entire period. It is a little more than 10% (the row where GOT is equal to 10% is italicized in the queue). Many people (even professionals) like to use this 10% return number to project returns. As you can see from the queue, a 10% GOT is only acceptable for people retiring in 30-35 years. Those are the only periods where the frequency is greater than 80%. That is also why it is better to use 8% in forward looking return calculations. It has a higher degree of likelihood of actually being achieved, including all periods extending beyond 25 years.

A 0% GOT means you are on course to accumulate the assets you need to achieve a comfortable retirement without getting any return on those assets. It means you do not have to take any risk at all. I'll leave that for you to decide for yourself or with the help of a professional adviser. For those who are well within the green and white shades of the queue, congratulations! You have an acceptable GOT.

All asset allocation systems and methods for financial advising are based on incomplete anomalies and statistical probabilities, particularly after the financial crisis of 2008. These asset allocation systems and methods are based on future projections and estimates as well as optimizing profits and returns. Many in the financial services community are unhappy with the asset allocation systems and methods for financial advising, since it often leaves customers unhappy and results often in brokers making big commissions at the expense of good customer service. The poor customer service that results from the asset allocation systems and methods for financial advising has led to the attempted development of other types systems and methods for financial advising based on criterion other than asset allocation. The attempt at maximizing returns and profits often does not address the actual goals of the customer, thereby adding to the negative customer service experience.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments may be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A system for financial advising based on a goal oriented target (GOT), comprising:
a server system with a processor system, a communications interface, a communications system, an input system and an output system, the server system having access to a communications network;
a memory system with an operating system, a communications module, a web browser module, a web server application and a financial advising based on a goal oriented target non-transitory storage media; and
a website with a plurality of interfaces for financial advising based on the goal oriented target.

2. The system according to claim 1, further comprising a client system, the client system comprises an output system, an input system, a memory system, a processor system and a communications system.

3. The system according to claim 2, wherein the client system accesses the server system via the communications network.

4. The system of claim 1, wherein the interfaces for financial advising based on the goal oriented target comprises a GOT input interface and a GOT output interface.

5. The system of claim 4, wherein the GOT input interface comprises a pair of gross annual salary fields, a pair of retirement savings fields, a pair of annual contribution fields, a years to retirement field, a projected retirement income needed field, a pair of override buttons, a pair of annual social security fields, a pair of annual pension fields and a pair of annual outside income fields.

6. The system of claim 5, wherein the GOT output interface comprises the pair of gross annual salary fields, the pair of retirement savings fields, the pair of annual contribution fields, the years to retirement field, the projected retirement income needed field, the pair of override buttons, the pair of annual social security fields, the pair of annual pension fields, the pair of annual outside income fields, a press to calculate button and a GOT percentage.

7. The system of claim 6, wherein the press to calculate button is depressed after the pair of gross annual salary fields, the pair of retirement savings fields, the pair of annual contribution fields, the years to retirement field, the projected retirement income needed field, the pair of override buttons, the pair of annual social security fields, the pair of annual pension fields and the pair of annual outside income fields are entered and completed, thereby generating the GOT percentage.

8. The system of claim 1, wherein the interfaces for financial advising based on the goal oriented target comprise a GOT versus frequency queue to indicate stability and value of GOT.

9. The system of claim 8, wherein the GOT versus frequency queue comprises a plurality of percent GOT values, a plurality of predetermined frequency terms, a plurality of corresponding percentages and a color coding system.

10. The system of claim 9, wherein the color coding system is coded where dark colored corresponding percentages have low GOT percentages and light colored corresponding percentages have high GOT percentages.

11. A method for financial advising based on a goal oriented target (GOT), said method comprising the steps of:
entering a plurality of calculating GOT information from a non-computer custodian system onto a GOT input interface of a website; and
activating the GOT input interface to generate a GOT percentage after the calculating GOT information is entered.

12. The method of claim 11, wherein the calculating GOT information comprises a pair of gross annual salary fields, a pair of retirement savings fields, a pair of annual contribution fields, a years to retirement field, a projected retirement income needed field, a pair of override buttons, a pair of annual social security fields, a pair of annual pension fields and a pair of annual outside income fields.

13. The method of claim 11, wherein the GOT percentage is activated after depressing a press to calculate button residing on the GOT input interface.

14. The method of claim 11, further comprising a color-coded GOT versus frequency queue that includes a plurality of percent GOT values, a plurality of predetermined frequency terms, a plurality of corresponding percentages and a color coding system, the color-coded GOT versus frequency queue indicates stability and value of GOT.

15. The method of claim 14, wherein the color coding system is coded where dark colored GOT percentages have low GOT percentages and light colored GOT percentages have high GOT percentages and is compared with the GOT percentage to indicate GOT percentage quality.

16. A non-transitory computer storage media having instructions stored thereon which, when executed, execute a method comprising the steps of:
entering a plurality of calculating Goal Oriented Target (GOT) information from a non-computer custodian system onto a GOT input interface of a website; and
activating the GOT input interface to generate a GOT percentage after the calculating GOT information is entered.

17. The non-transitory computer storage media of claim 16, wherein the calculating GOT information comprises a pair of gross annual salary fields, a pair of retirement savings fields, a pair of annual contribution fields, a years to retirement field, a projected retirement income needed field, a pair of override buttons, a pair of annual social security fields, a pair of annual pension fields and a pair of annual outside income fields.

18. The non-transitory computer storage media of claim 16, wherein the GOT percentage is activated after depressing a press to calculate button residing on the GOT input interface.

19. The non-transitory computer storage media of claim 16, further comprising a color-coded GOT versus frequency queue that includes a plurality of percent GOT values, a plurality of predetermined frequency terms, a plurality of corresponding percentages and a color coding system, the color-coded GOT versus frequency queue indicates stability and value of GOT.

20. The non-transitory computer storage media of claim 19, wherein the color coding system is coded where dark colored GOT percentages have low GOT percentages and light colored GOT percentages have high GOT percentages and is compared with the GOT percentage to indicate GOT percentage quality.
